(19) United States
(12) Patent Application Publication
(10) Pub. No.: US 2017/0174463 A1
(43) Pub. Date: Jun. 22, 2017

(54) Apparatus and Method for Producing Stacks of Partially Overlapping Labels and Roll of Partially Overlapping Labels

(71) Applicant: ETI Converting Equipment, Boucherville (CA)

(72) Inventors: Francois Bayzelon, Quebec (CA); Maxime Bayzelon, La Prairie (CA); Wei Xuan, Shanghai (CN)

(21) Appl. No.: 15/447,485

(22) Filed: Mar. 2, 2017

Related U.S. Application Data
(63) Continuation of application No. PCT/CA2014/000672, filed on Sep. 3, 2014.

(51) Int. Cl. B65H 29/66; G09F 3/10; B65H 29/54; B31D 1/02; B65H 29/00

(52) U.S. Cl. CPC B65H 29/6627; B31D 1/021; B65H 29/006; B65H 29/54; G09F 3/10; B31D 2201/02; B65H 2301/41922; B65H 2301/44735; B65H 2701/192; G09F 2003/0229

(57) ABSTRACT

A roll of labels, each of the labels having a label side and an adhesive side, the roll comprising a stack of partially overlapping labels winded around a core structure. The label side of the first label of the stack, closest to the core structure, is on top of the stack. The roll also comprises a liner provided under a non-overlapping portion on the adhesive side of the partially overlapping labels. A method, and an apparatus, for stacking labels comprising conveying a plurality of individual labels at a first speed and transferring each of the plurality of individual labels to form a stack of labels running at a second speed lower than the first speed, thereby causing the transferred labels to be stacked in a partially overlapping configuration.

### CROSS-REFERENCE TO RELATED APPLICATION

This application is a continuation of and claims priority to PCT/CA2014/000672, filed on Sep. 3, 2014, the disclosure of which is incorporated herein by reference in its entirety.

### TECHNICAL FIELD

The present invention relates to adhesive labels and more particularly to label stacking.

### BACKGROUND

Product labeling is often performed by applying a label on the product packaging. The label application may be done at the packaging facility from a roll of labels prepared on site or at a remote location. Each roll of labels comprises waste material. Transport and/or storage of rolls, if applicable, also require resources and space.

The present invention aims at more resource-efficient rolls of labels and/or at technologies that allow for the eventual production of more resource-efficient rolls of labels.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a roll of labels, each of the labels having a label side and an adhesive side. The roll comprises a stack of partially overlapping labels winded around a core structure. The label side of the first label of the stack, closest to the core structure, is on top of the stack. The roll also comprises a liner provided under a non-overlapping portion on the adhesive side of the partially overlapping labels.

Optionally, the stack of partially overlapping labels over the liner is the only stack on the roll (or uninterrupted).

In one set of embodiments, the liner may be facing the core structure.

The liner may be at least as wide as the label width or narrower than the label width. The narrower liner may be positioned in the center of the stacker may also be spooled on the label width. The liner may also comprise more than one liner strip, each strip being narrower than the label width. The strips may be equidistantly positioned from the center of the stack.

A second aspect of the present invention is directed to an apparatus for stacking labels. The apparatus comprises a first conveyor running at a first speed for conveying a plurality of individual labels at the first speed. The apparatus also comprises a label stacker for transferring each of the plurality of individual labels to form a stack of labels running at a second speed lower than the first speed, thereby causing the transferred labels to be stacked in a partially overlapping configuration. The ratio between the first speed and the second speed may be used to adjust an overlap length of the stack of labels.

Optionally, the apparatus may further comprise a second conveyor for forming the stack of labels thereon. The second conveyor may be a vacuum conveyor.

In the present context, it is assumed that each of the labels has a label side opposite an adhesive side. The label stacker may be used for transferring each of the plurality of individual labels exiting from a nip at the end of the first conveyor with the label side facing the stack of labels.

Optionally, the apparatus may further comprise a liner applicator for applying a liner on an adhesive side of the partially overlapping stacked labels. The liner may be narrower than the label width and the liner applicator may further spool the liner on the label width. The liner applicator may also be integrated with the label stacker.

The apparatus may also comprise a roller for forming a roll from the stack of overlapping labels.

A third aspect of the present invention is directed to a method for stacking labels comprising conveying a plurality of individual labels at a first speed and transferring each of the plurality of individual labels to form a stack of labels running at a second speed lower than the first speed, thereby causing the transferred labels to be stacked in a partially overlapping configuration.

Optionally, the method may further comprise adjusting a ratio between the first speed and the second speed to determine an overlap length of the stack of labels.

Conveying the plurality of labels may optionally be performed on a first conveyor running at the first speed, the stack of labels being formed onto a second conveyor running at the second speed.

In the present context, it is assumed that each of the labels has a label side opposite an adhesive side. Transferring each of the plurality of individual labels may be performed from a nip at the end of the first conveyor with the label side facing the stack of labels.

Optionally, the method may further comprise applying a liner on an adhesive side of the partially overlapping stacked labels. The liner may be narrower than the label width and applying the liner may further comprise spooling the liner on the label width.

Optionally, the method may further comprise forming a roll from the stack of overlapping labels.

### BRIEF DESCRIPTION OF THE DRAWINGS

Further features and exemplary advantages of the present invention will become apparent from the following detailed description, taken in conjunction with the appended drawings, in which:

FIG. 1 is a perspective view of an exemplary apparatus for producing stacked labels in accordance with the teachings of the present invention;

FIG. 2 is a flow chart of an exemplary process for producing stacked labels in accordance with the teachings of the present invention;

FIG. 3 is a perspective view of an exemplary roll of stacked labels in accordance with the teachings of the present invention;

FIGS. 4A and FIG. 4B herein referred to concurrently as FIG. 4 are respectively a perspective view and a side view of an exemplary stack of labels on a full-width liner in accordance with the teachings of the present invention;

FIG. 5A, FIG. 5B, FIG. 5C and FIG. 5D herein referred to concurrently as FIG. 5 are a top view and three bottom views of exemplary “stack under” partially overlapping labels in accordance with the teachings of the present invention;

FIGS. 6A and FIG. 6B herein referred to concurrently as FIG. 6 are respectively a top view and a bottom view of exemplary “stack over” partially overlapping labels in accordance with the teachings of the present invention;

FIG. 7 is a perspective view of an exemplary apparatus with a laser die cutting station for producing stacked labels in accordance with the teachings of the present invention;

FIG. 8 is a perspective view of an exemplary apparatus for producing “stack over” partially overlapping labels in accordance with the teachings of the present invention; and

FIG. 9 is a perspective view of an exemplary apparatus with a laser die cutting station for producing “stack over” partially overlapping labels in accordance with the teachings of the present invention.

### DETAILED DESCRIPTION

The present invention allows for increased density of a roll of labels by stacking partially overlapping labels and producing one or more rolls from the partially overlapping labels. If the characteristics of the roll and the stacked labels are set properly and provide increased density, then environmental gains are to be expected, for instance, in the amount of waste material produced for each roll and in the resources required for the transport and/or storage of the rolls. The stacked labels may be put on a liner (or one or more strips of liner) on the adhesive side of the labels. It is, however, also possible to stack the labels and to produce rolls from the stacked labels without a liner. During the label stacking, the adhesive side may be provided on top or on the bottom of the stack being produced. The production of the rolls may be performed with the adhesive side facing away from the center of the roll or towards the center of the roll, with the first available label from the stack having its adhesive side fully exposed or having its label side fully exposed.

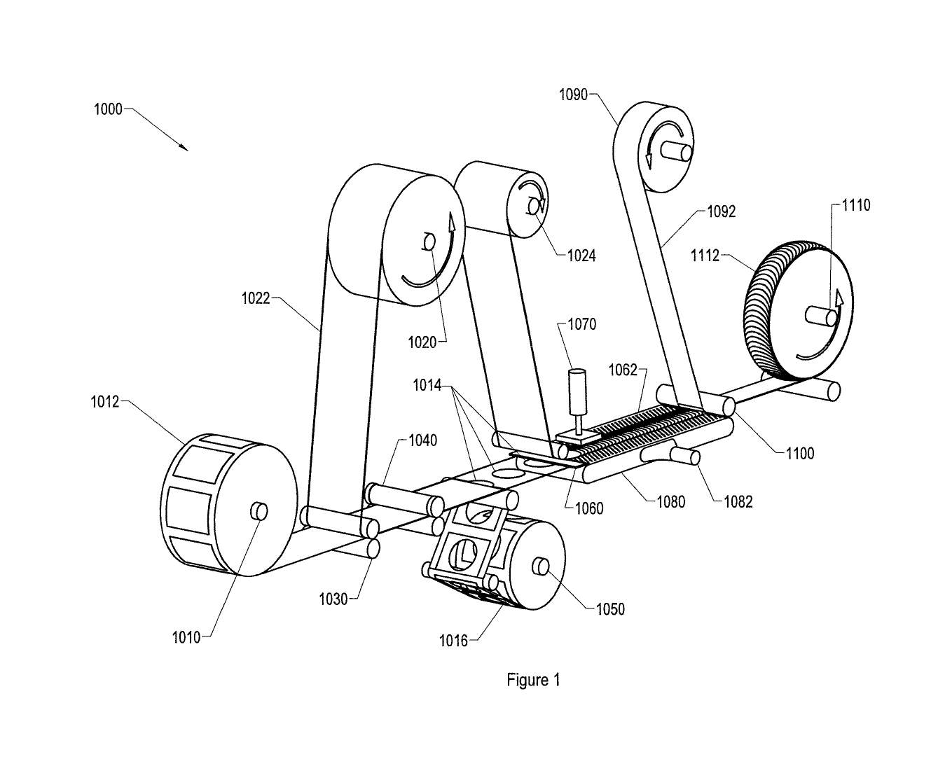

Reference is now made to the drawings in which FIG. 1 shows a perspective view of an exemplary apparatus 1000 for producing stacked labels in accordance with the teachings of the present invention. In the depicted embodiment, the apparatus 1000 is adapted to produce stacked labels from a pre-printed linerless roll of uncut labels 1012. The roll of pre-preprinted uncut labels 1012 is positioned on an uncut-labels-unwinder 1010 of the apparatus 1000. In the depicted example, a process liner 1022 is used during the cutting of the pre-printed uncut labels 1012. The apparatus 1000 comprises a process-liner-unwinder 1020 to feed the process liner 1022 and a process-liner-rewinder 1024 to rewind the process liner 1022. In some embodiments, the process liner 1022 is reused more than once. In other embodiments, a continuous process liner (not shown) may also be used, which may further require a tension equalizer (not shown). In other embodiments, the uncut labels may be provided with the process liner already on the roll (not shown).

In the depicted example, the apparatus 1000 also comprises pull rolls 1030 that are used to pull on the pre-preprinted uncut labels 1012 as well as the process liner 1022, which are fed together towards a cutting station 1040. The pull rolls 1030 set a first speed for the process liner 1022. The process liner 1022, as will be shown later, acts as a first conveyor in the apparatus 1000.

The cutting station 1040 of the apparatus 1000 as depicted on FIG. 1 is a simple die cutting station. Skilled persons will readily understand that other types of cutting stations (e.g., laser cutting) or a more complex die cutting station may also be used without affecting the teachings of the present invention.

After the die cutting station, cut labels 1014 are kept on the process liner 1022 while waste material 1016 from the pre-preprinted uncut labels 1012 is rewinded on a waste-material-rewinder 1050. In the perspective of FIG. 1, the cut labels 1014 travel under the process liner 1022 with their adhesive side facing up, and the process liner 1022 is depicted as transparent. A skilled person will readily understand how to adapt the depicted example to permit the cut labels 1014 to travel above the process liner 1022 and that the process liner 1022 could be opaque without affecting the teachings of the present invention.

The process liner 1022 then acts as the first conveyor and takes the cut labels 1014 from the cutting station 1040 to a peeling station 1060. The peeling station 1060 may provide a nip that causes the cut label 1014 to be separated from the process liner 1022. A label stacker 1070 then transfers the cut labels 1014 to a second conveyor 1080 running at a second speed lower than the speed of the process liner 1022 as set by the pull rolls 1030. The cut labels 1014 alternatively may be stacked on the second conveyor 1080 directly from the cutting station 1040 (not shown).

The label stacker 1070 of the apparatus 1000 as depicted on FIG. 1 is a kicker that takes the cut labels 1014 one at a time from the peeling station 1060 and stacks them into a stack of partially overlapping labels 1062 on the second conveyor 1080. The ratio between the first speed and the second speed is used to adjust an overlap length of the stack of labels. The overlap length and the characteristics of individual cut labels 1014 determine an overlap ratio for the stack of partially overlapping labels 1062. The overlap ratio or the overlap length may be set in view of known characteristics of a labeling apparatus to which it will be fed.

A roll of final liner 1092 is positioned on a liner-unwinder 1090 of the apparatus 1000. The liner 1092 is laminated with the stack of labels 1062 at a laminator 1100 to form a stack of partially overlapping labels on a liner 1112. The stack of labels of the liner 1112 is then winded on a roll 1110. The roll may be formed by surface winding. The stack of labels 1062 or the stack of labels of the liner 1112 may alternatively be sent directly to the labeling apparatus (not shown).

The exemplary second conveyor 1080 of the apparatus 1000 provides a vacuum port 1082 to operate the second conveyor 1080 as a vacuum conveyor. The vacuum aspect may be necessary only in certain embodiments (e.g., stack-under) and/or only during an initialization phase of the apparatus 1000 (i.e., until the stack of labels 1062 reach the laminator 1100).

In some other embodiments, a roll is formed from the stack of labels 1062 without the final liner 1092 (not shown).

In some other embodiments, the cut labels 1014 may be stacked on the final liner 1092 directly from the peeling station 1060 or the cutting station 1040 (not shown).

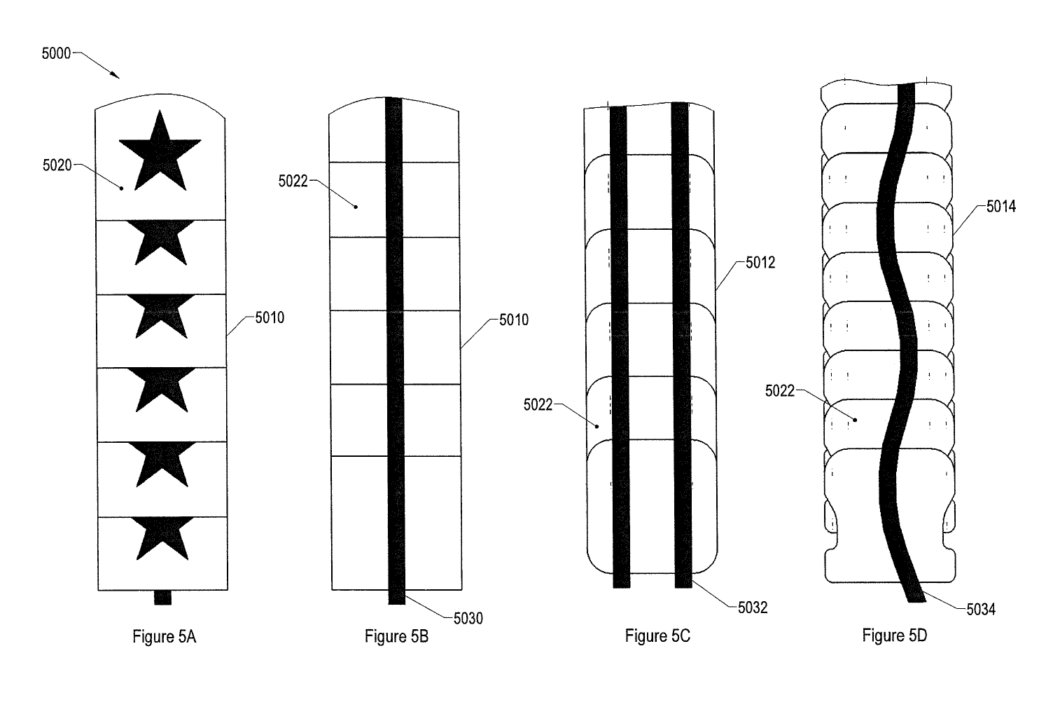

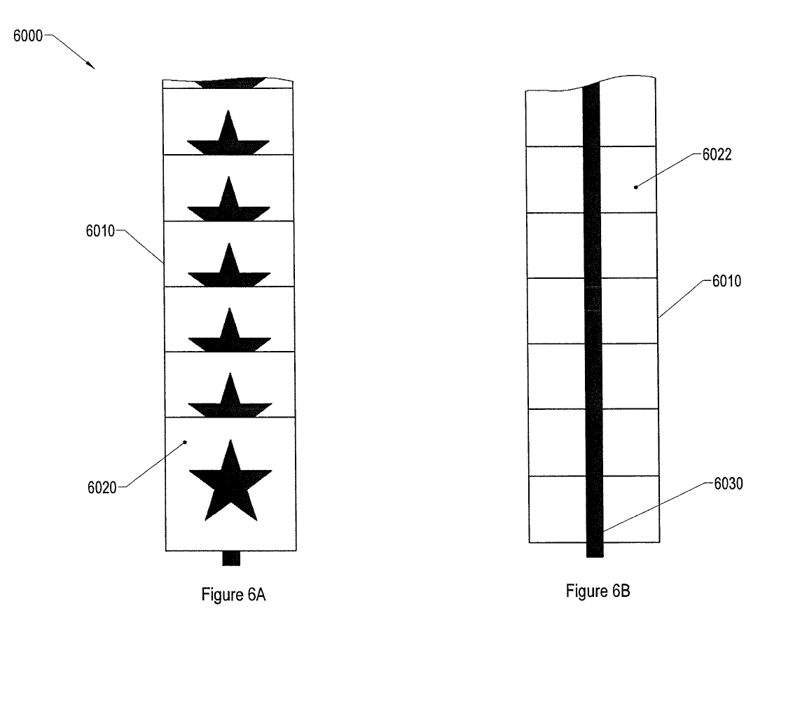

The configuration of the exemplary apparatus 1000 provides for the “stack-under” partially overlapping labels 1062, as will be more apparent with reference to FIG. 5. Other embodiments of the apparatus 1000 may also provide for “stack-over” partially overlapping labels (not shown on FIG. 1), as will be more apparent with reference to FIG. 6.

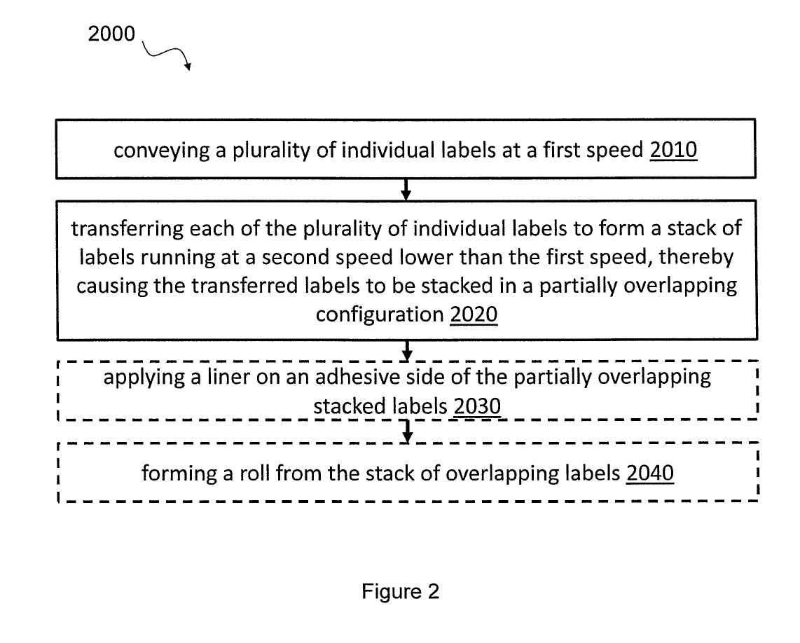

FIG. 2 shows a flow chart of an exemplary process 2000 for producing stacked labels in accordance with the teachings of the present invention. The process 2000 comprises conveying a plurality of individual labels at a first speed 2010 and transferring each of the plurality of individual labels to form a stack of labels running at a second speed lower than the first speed, thereby causing the transferred labels to be stacked in a partially overlapping configuration 2020. Optionally, the process 2000 may comprise applying a liner on an adhesive side of the partially overlapping stacked labels 2030. The process 2000 may also comprise forming a roll from the stack of overlapping labels 2040. The process 2000 may alternatively comprise passing the stacked labels directly to a labeling apparatus (not shown).

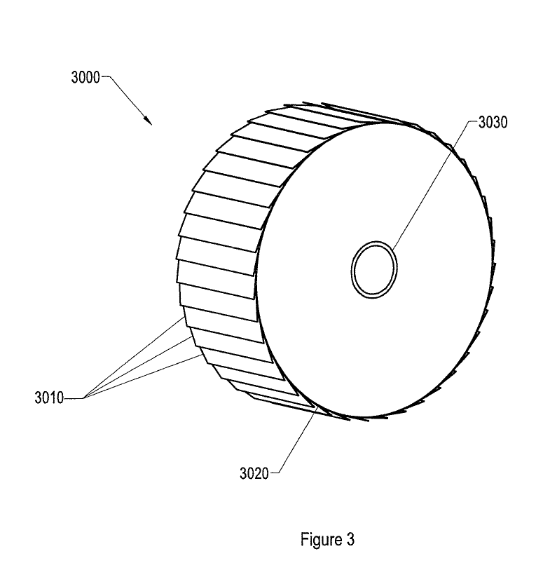

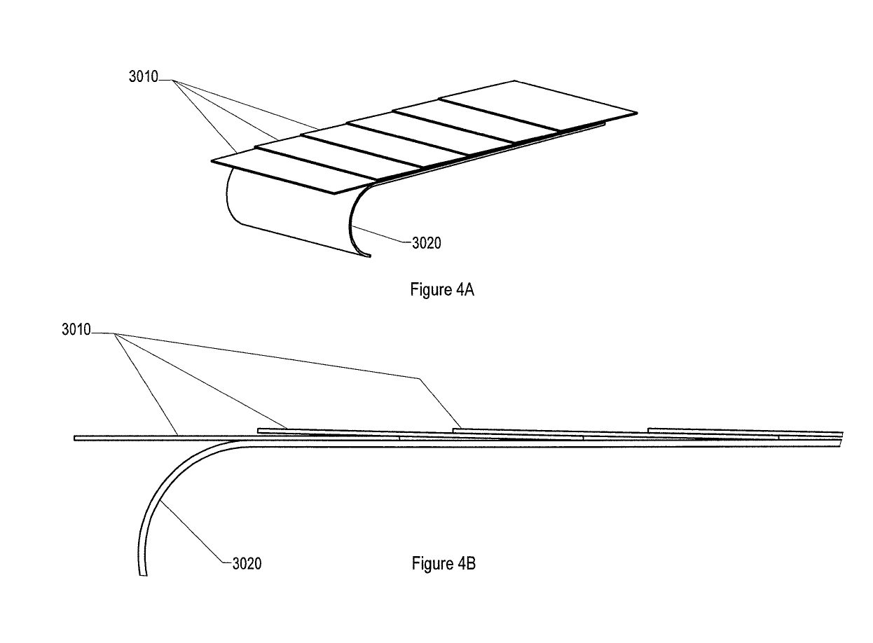

Reference is now made concurrently to the example depicted on FIGS. 3 and 4. FIG. 3 shows a perspective view of an exemplary roll 3000 of exemplary stacked labels 3010. The roll 3000 comprises a plurality of partially overlapping stacked labels 3010 on a full-width liner 3020. FIG. 4 shows a perspective view and a side view of the exemplary stacked labels 3010 on the full-width liner 3020. The roll 3000 comprises a core structure 3030 around which the stacked labels 3010 are winded. In the example of FIGS. 3 and 4, the label side of the first label of the stack, closest to the core structure 3030, is on top of the stack (stack-under). The liner 3020 is provided under a non-overlapping portion on the adhesive side of the partially overlapping labels. As depicted, the liner 3020 is facing the core structure 3030. Skilled person will understand that other configurations of the roll 3000 may also be provided (e.g., with the liner 3020 on the outside and/or with the adhesive side of the first label of the stack, closest to the core structure 3030, on the top of the stack (stack-under)).

FIGS. 5A, FIG. 5B, FIG. 5C and FIG. 5D herein referred to concurrently as FIG. 5 show a top view and three bottom views of exemplary “stack-under” partially overlapping labels 5000 in accordance with the teachings of the present invention. On FIG. 5, a label side 5020 of the first label is on top of the stack of labels 5010, 5012 or 5014. An adhesive side 5022 is fully exposed when the liner 5030, 5032, 5034 is removed from the stack. While FIG. 4A depicted a full-width liner 3020, FIGS. 5B, 5C and 5D provide other exemplary liner configurations 5030, 5032 and 5034. The liner may also be wider than the label width (not shown). More specifically, the liner 5030, 5032 and 5034 are narrower than the label width.

The liner 5030 is positioned in the center of the stack, but may also be positioned anywhere along the width of the label. Furthermore, the liner could be at the boundary of the label (not shown) and may further be extending beyond the boundary (not shown).

The liner 5032 comprise more than one liner strips. In the example shown, each strip is narrower than the label width. However, one ore more of the strips could also extend beyond the label boundary and some or all of the strips may thus be wider than the label (not shown). The liner 5032 shows two strips, but more strips may be provided in different contexts (not shown). The strips may be equidistantly positioned, as shown, from the center of the stack, as depicted, but may also be provided with in different configurations.

The liner 5034 is spooled on the label width. More than one strip could be spooled on the label width. The liner 5034 may be provided as a curved liner or may be spooled during the lamination process (e.g., by a spooler of the laminator 1100). The liner may also be composed of a mesh (not shown) comprises openings. A spooled liner may provide the advantage of limiting and/or distributing longitudinal tensions in the stack of labels.

FIGS. 6A and FIG. 6B herein referred to concurrently as FIG. 6 show respectively a top view and a bottom view of exemplary “stack-over” partially overlapping labels 6000 in accordance with the teachings of the present invention. On FIG. 6, an adhesive side 6022 is partially exposed when the liner 6030 is removed from the stack. A label side 6020 of the last label is top of the stack of labels 6010. the different exemplary liners depicted previously apply equally to stack-over or stack-under configurations.

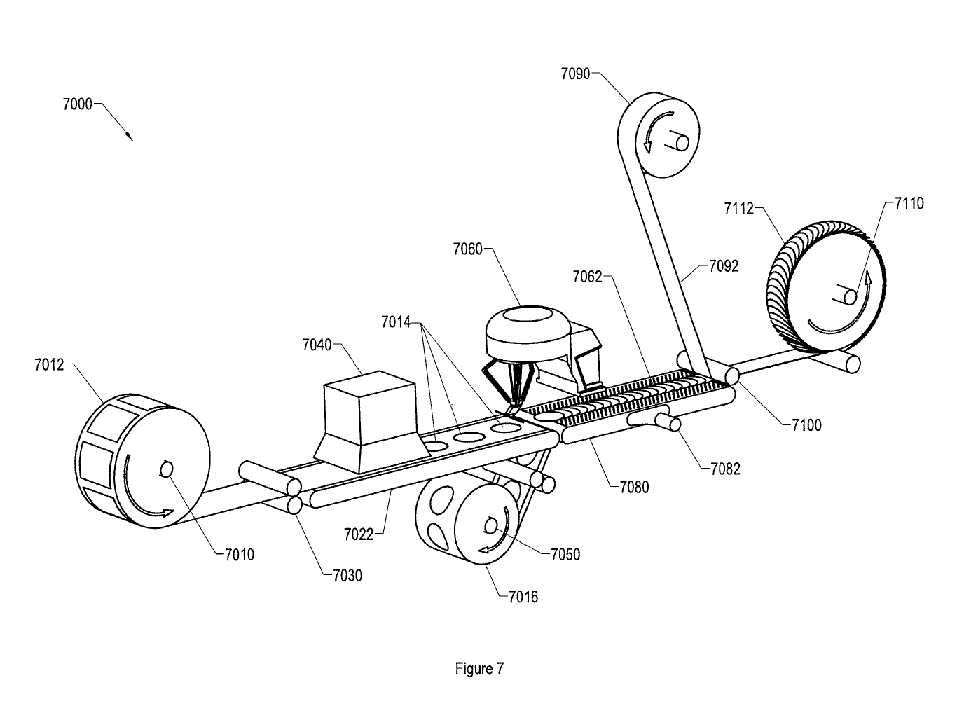

Reference is now made to the drawings in which FIG. 7 shows a perspective view of an exemplary apparatus 7000 for producing stacked labels in accordance with the teachings of the present invention. In the depicted embodiment, the apparatus 7000 is adapted to produce stacked labels from a pre-printed linerless roll of uncut labels 7012. The roll of pre-preprinted uncut labels 7012 is positioned on an uncut-labels-unwinder 7010 of the apparatus 7000. In the depicted example, a steel belt conveyor 7022 is used during the cutting of the pre-printed uncut labels 7012.

In the depicted example, the apparatus 7000 also comprises pull rolls 7030 that are used to pull on the pre-preprinted uncut labels 7012, which are fed together towards a cutting station 7040. The pull rolls 7030 set a first speed for the pre-preprinted uncut labels 7012.

The cutting station 7040 of the apparatus 7000 as depicted on FIG. 7 is a laser die cutting station.

After the die cutting station 7040, cut labels 7014 are kept on the steel belt conveyor 7022 with their adhesive side facing up. A skilled person will readily understand how to adapt the depicted example to permit the cut labels 7014 to be kept on the steel belt conveyor 7022 with their adhesive side facing down. Waste material 7016 from the pre-preprinted uncut labels 7012 is rewinded on a waste-material-rewinder 7050.

The steel belt conveyor 7022 then acts as the first conveyor and takes the cut labels 7014 from the cutting station 7040 to a pick and place robot 7060. The pick and place robot 7060 then transfers the cut labels 7014 to a second conveyor 7080 running at a second speed lower than the speed of the steel belt conveyor 7022 as set by the pull rolls 7030.

The pick and place robot 7060 of the apparatus 7000 as depicted on FIG. 7 takes the cut labels 7014 one at a time from the steel belt conveyor 7022 and stacks them into a stack of partially overlapping labels 7062 on the second conveyor 7080. The ratio between the first speed and the second speed is used to adjust an overlap length of the stack of labels. The overlap length and the characteristics of individual cut labels 7014 determine an overlap ratio for the stack of partially overlapping labels 7062. The overlap ratio or the overlap length may be set in view of known characteristics of a labeling apparatus to which it will be fed.

A roll of final liner 7092 is positioned on a liner-unwinder 7090 of the apparatus 7000. The liner 7092 is laminated with the stack of labels 7062 at a laminator 7100 to form a stack of partially overlapping labels on a liner 7112. The stack of labels of the liner 7112 is then winded on a roll 7110. The roll may be formed by surface winding. The stack of labels 7062 or the stack of labels on the liner 7112 may alternatively be sent directly to the labeling apparatus (not shown).

The exemplary second conveyor 7080 of the apparatus 7000 provides a vacuum port 7082 to operate the second conveyor 7080 as a vacuum conveyor. The vacuum aspect may be necessary only in certain embodiments (e.g., stack-under) and/or only during an initialization phase of the apparatus 7000 (i.e., until the stack of labels 7062 reach the laminator 7100).

In some other embodiments, a roll is formed from the stack of labels 7062 without the final liner 7092 (not shown).

The configuration of the exemplary apparatus 7000 provides for the “stack-under” partially overlapping labels 7062, as will be more apparent with reference to FIG. 5. Other embodiments of the apparatus 7000 may also provide for “stack-over” partially overlapping labels (not shown on FIG. 7) , as will be more apparent with reference to FIG. 6.

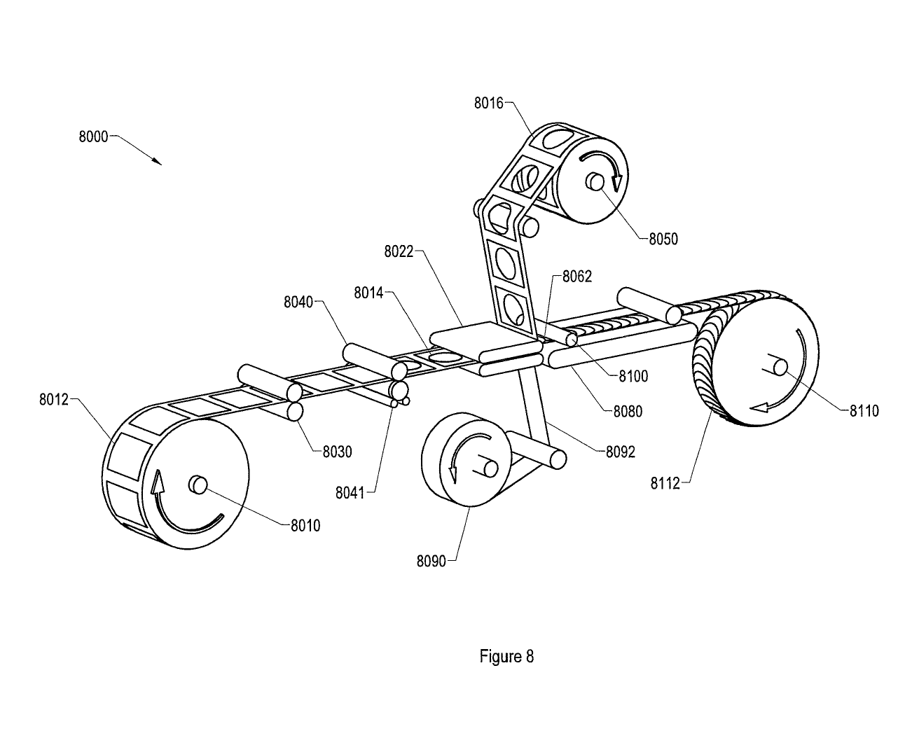

Reference is now made to the drawings in which FIG. 8 shows a perspective view of an exemplary apparatus 8000 for producing stacked labels in accordance with the teachings of the present invention. In the depicted embodiment, the apparatus 8000 is adapted to produce stacked labels from a pre-printed linerless roll of uncut labels 8012. The roll of pre-preprinted uncut labels 8012 is positioned on an uncut-labels-unwinder 8010 of the apparatus 8000.

In the depicted example, the apparatus 8000 also comprises pull rolls 8030 that are used to pull on the pre-preprinted uncut labels 8012, which are fed together towards a cutting station 8040. The pull rolls 8030 set a first speed for the pre-preprinted uncut labels 8012.

The cutting station 8040 of the apparatus 8000 as depicted on FIG. 8 is a simple die cutting station. The cutting station 8040 includes an oiling system 8041. Skilled persons will readily understand that other types of cutting stations (e.g., laser cutting) or a more complex die cutting station may also be used without affecting the teachings of the present invention.

After the die cutting station 8040, cut labels 8014 pass through a conveyor 8022. Waste material 8016 from the pre-preprinted uncut labels 8012 is rewinded on a waste-material-rewinder 8050.

The conveyor 8022 then acts as the first conveyor and transfers the cut labels 8014 to a second conveyor 8080 running at a second speed lower than the speed of the conveyor 8022 as set by the pull rolls 8030.

The conveyor 8022 of the apparatus 8000 as depicted on FIG. 8 takes the cut labels 8014 one at a time and stacks them into a stack of partially overlapping labels 8062 on the second conveyor 8080 with their adhesive side facing down. A skilled person will readily understand how to adapt the depicted example to stack the cut labels 8014 on the second conveyor 8080 with their adhesive side facing up. The ratio between the first speed and the second speed is used to adjust an overlap length of the stack of labels. The overlap length and the characteristics of individual cut labels 8014 determine an overlap ratio for the stack of partially overlapping labels 8062. The overlap ratio or the overlap length may be set in view of known characteristics of a labeling apparatus to which it will be fed.

A roll of final liner 8092 is positioned on a liner-unwinder 8090 of the apparatus 8000. The liner 8092 is laminated with the stack of labels 8062 at a laminator 8100 to form a stack of partially overlapping labels on a liner 8112. The stack of labels of the liner 8112 is then winded on a roll 8110. The roll may be formed by surface winding. The stack of labels 8062 or the stack of labels on the liner 8112 may alternatively be sent directly to the labeling apparatus (not shown).

In some other embodiments, a roll is formed from the stack of labels 8062 without the final liner 8092 (not shown).

The configuration of the exemplary apparatus 8000 provides for the “stack-over” partially overlapping labels 8062, as will be more apparent with reference to FIG. 6.

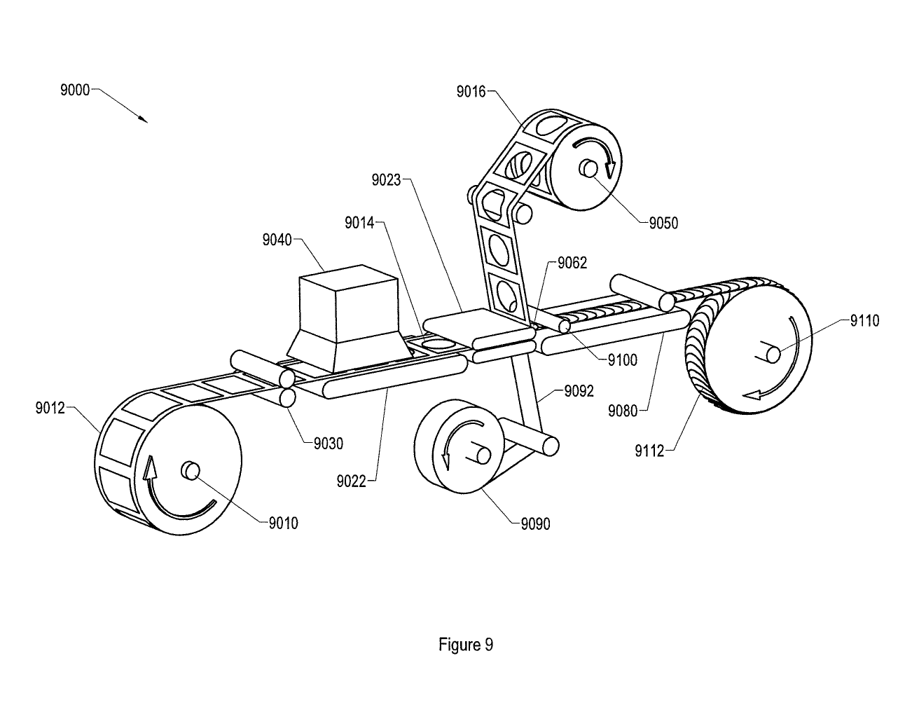

Reference is now made to the drawings in which FIG. 9 shows a perspective view of an exemplary apparatus 9000 for producing stacked labels in accordance with the teachings of the present invention. In the depicted embodiment, the apparatus 9000 is adapted to produce stacked labels from a pre-printed linerless roll of uncut labels 9012. The roll of pre-preprinted uncut labels 9012 is positioned on an uncut-labels-unwinder 9010 of the apparatus 9000. In the depicted example, a steel belt conveyor 9022 is used during the cutting of the pre-printed uncut labels 9012.

In the depicted example, the apparatus 9000 also comprises pull rolls 9030 that are used to pull on the pre-preprinted uncut labels 9012, which are fed together towards a cutting station 9040. The pull rolls 9030 set a first speed for the pre-preprinted uncut labels 9012.

The cutting station 9040 of the apparatus 9000 as depicted on FIG. 9 is a laser die cutting station.

After the die cutting station 9040, cut labels 9014 are kept on the steel belt conveyor 9022 with their adhesive side facing down before passing through a conveyor 9023. A skilled person will readily understand how to adapt the depicted example to keep the cut labels 9014 on the steel belt conveyor 9022 with their adhesive side facing up. Waste material 9016 from the pre-preprinted uncut labels 9012 is rewinded on a waste-material-rewinder 9050.

The conveyor 9023 then acts as the second conveyor and transfers the cut labels 9014 to a third conveyor 9080 running at a second speed lower than the speed of the conveyors 9022 and 9023 as set by the pull rolls 9030.

The conveyor 9023 of the apparatus 9000 as depicted on FIG. 9 takes the cut labels 9014 one at a time and stacks them into a stack of partially overlapping labels 9062 on the third conveyor 9080. The ratio between the first speed and the second speed is used to adjust an overlap length of the stack of labels. The overlap length and the characteristics of individual cut labels 9014 determine an overlap ratio for the stack of partially overlapping labels 9062. The overlap ratio or the overlap length may be set in view of known characteristics of a labeling apparatus to which it will be fed.

A roll of final liner 9092 is positioned on a liner-unwinder 9090 of the apparatus 9000. The liner 9092 is laminated with the stack of labels 9062 at a laminator 9100 to form a stack of partially overlapping labels on a liner 9112. The stack of labels of the liner 9112 is then winded on a roll 9110. The roll may be formed by surface winding. The stack of labels 9062 or the stack of labels on the liner 9112 may alternatively be sent directly to the labeling apparatus (not shown).

In some other embodiments, a roll is formed from the stack of labels 9062 without the final liner 9092 (not shown).

The configuration of the exemplary apparatus 9000 provides for the “stack-over” partially overlapping labels 9062, as will be more apparent with reference to FIG. 6.

Going back to the example of FIG. 1, in order to adapt the apparatus 1000 to a stack over configuration, the process liner 1022 and the pre-preprinted uncut labels 1012 could be inverted. Skilled persons will readily understand that other adaptations could be made to provide for the same result.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses. Figures are not necessarily drawn to scale.

What is claimed is:

1. A roll of labels, each of the labels having a label side and an adhesive side, the roll comprising:
a stack of partially overlapping labels winded around a core structure, wherein the label side of the first label of the stack, closest to the core structure, is on top of the stack;
a liner provided under a non-overlapping portion on the adhesive side of the partially overlapping labels.

2. The roll of claim 1, wherein the stack of partially overlapping labels over the liner is the only stack on the roll.

3. The roll of claim 1, wherein the liner is facing the core structure.

4. The roll of claim 1, wherein the liner is at least as wide as the label width.

5. The roll of claim 1, wherein the liner is narrower than the label width.

6. The roll of claim 5, wherein the liner is positioned in the center of the stack.

7. The roll of claim 5, wherein the liner is spooled on the label width.

8. The roll of claim 1, wherein the liner comprises more than one liner strips, each strip being narrower than the label width.

9. The roll of claim 8, wherein the strips are equidistantly positioned from the center of the stack.

10. An apparatus for stacking labels comprising:
a first conveyor running at a first speed for conveying a plurality of individual labels at the first speed; and
a label stacker for transferring each of the plurality of individual labels to form a stack of labels running at a second speed lower than the first speed, thereby causing the transferred labels to be stacked in a partially overlapping configuration.

11. The apparatus of claim 10, wherein the ratio between the first speed and the second speed is used to adjust an overlap length of the stack of labels.

12. The apparatus of claim 10 further comprising a second conveyor for forming the stack of labels thereon.

13. The apparatus of claim 11, wherein the second conveyor is a vacuum conveyor

14. The apparatus of claim 10, wherein each of the labels has a label side opposite an adhesive side, the label stacker being for transferring each of the plurality of individual labels exiting from a peeling station at the end of the first conveyor with the label side facing the stack of labels.

15. The apparatus of claim 10 further comprising a liner applicator for applying a liner on an adhesive side of the partially overlapping stacked labels.

16. The apparatus of claim 14, wherein the liner is narrower than the label width and the liner applicator spools the liner on the label width.

17. The apparatus of claim 14, wherein the liner applicator is integrated with the label stacker.

18. The apparatus of claim 10 further comprising a roller for forming a roll from the stack of overlapping labels.

19. A method for stacking labels comprising:
conveying a plurality of individual labels at a first speed; and
transferring each of the plurality of individual labels to form a stack of labels running at a second speed lower than the first speed, thereby causing the transferred labels to be stacked in a partially overlapping configuration.

20. The method of claim 19, further comprising adjusting a ratio between the first speed and the second speed to determine an overlap length of the stack of labels.

21. The method of claim 19, wherein conveying the plurality of labels is performed on a first conveyor running at the first speed, the stack of labels being formed onto a second conveyor running at the second speed.

22. The method of claim 21, wherein each of the labels has a label side opposite an adhesive side, transferring each of the plurality of individual labels being performed from a peeling station at the end of the first conveyor with the label side facing the stack of labels.

23. The method of claim 19, further comprising applying a liner on an adhesive side of the partially overlapping stacked labels.

24. The method of claim 19, wherein the liner is narrower than the label width, applying the liner further comprising spooling the liner on the label width.

25. The method of claim 19, further comprising forming a roll from the stack of overlapping labels.
